(19) United States
(12) Patent Application Publication
(10) Pub. No.: US 2003/0056326 A1
(43) Pub. Date: Mar. 27, 2003

(54) Connecting member of a slide of a window covering assembly allowing interchange of window coverings

(76) Inventor: Kuentin Ko, Kaohsiung City (TW)

Correspondence Address: Chang Chia Wei, P.O. Box 25-7, Kaohsiung City, 811, TW

(21) Appl. No.: 09/961,336

(22) Filed: Sep. 25, 2001

(51) Int. Cl. E05D 11/10

(52) U.S. Cl. 16/336

(57) ABSTRACT

A connecting member of a slide of a window covering assembly comprises a lower end branching into two clamping elements each having a hook on an inner face thereof for releasably engaging with a first type of window coverings. Each clamping element further comprises an engaging member for releasably engaging with a second type of window coverings.

### BACKGROUND OF THE INVENTION

1. Field of the Invention

The present invention relates to a connecting member of a slide of a window covering assembly allowing interchange of window coverings.

2. Description of the Related Art

Window coverings provide a sunlight-shielding effect as well as privacy protection. Some of the window coverings comprise plural slats which can be adjusted in angular positions thereof to change the incident angle of light, and others comprise a curtain, drape, lace, casement, print, or the like that can be manipulated to adjust the quantity of the incident light beams while providing decoration or other purpose.

FIG. 1 of the drawings illustrates a conventional window covering assembly comprising plural slides 1 slidably mounted on a rod 5 and plural slats 4. Each slide 1 has a connecting member 11 to which an upper end of a respective slat 4 is engaged. Since the slats 4 are made of plastic material and are thus rigid and smooth, the lower end of the connecting member 11 is branched into two clamping elements 111 and 112 each having a hook 113, 114 for securely engaging with a hole (not shown) of the respective slat 4. The slats 4 can be adjusted in angular positions thereof to change the incident angle of light.

FIG. 2 of the drawings illustrates another conventional window covering assembly comprising a rod 6 and plural slides 24 slidably mounted to the rod 6. A curtain 2 comprises plural hooks 23 that are respectively engaged with the slides 24 to move therewith. Thus, the curtain 2 can be manipulated to adjust the quantity of the incident light beams and to provide a romantic atmosphere.

However, when the user wishes to change the slats with the curtain or vice versa, it is also necessary to replace all of the slides. The cost, time, and difficulty of the assembly procedure are increased.

### SUMMARY OF THE INVENTION

An object of the present invention is to provide a connecting member of a slide of a window covering assembly allowing interchange of window coverings. Thus, the window covering assembly of the present invention can be used with different types of window coverings, and the replacement of the window coverings can be easily and quickly achieved without the need of replacing the connecting members to which the window coverings are attached.

A connecting member of a slide of a window covering assembly in accordance with the present invention comprises a lower end branching into two clamping elements each having a hook on an inner face thereof for releasably engaging with a first type of window coverings. Each clamping element further comprises an engaging member for releasably engaging with a second type of window coverings.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a portion of a conventional window covering assembly.

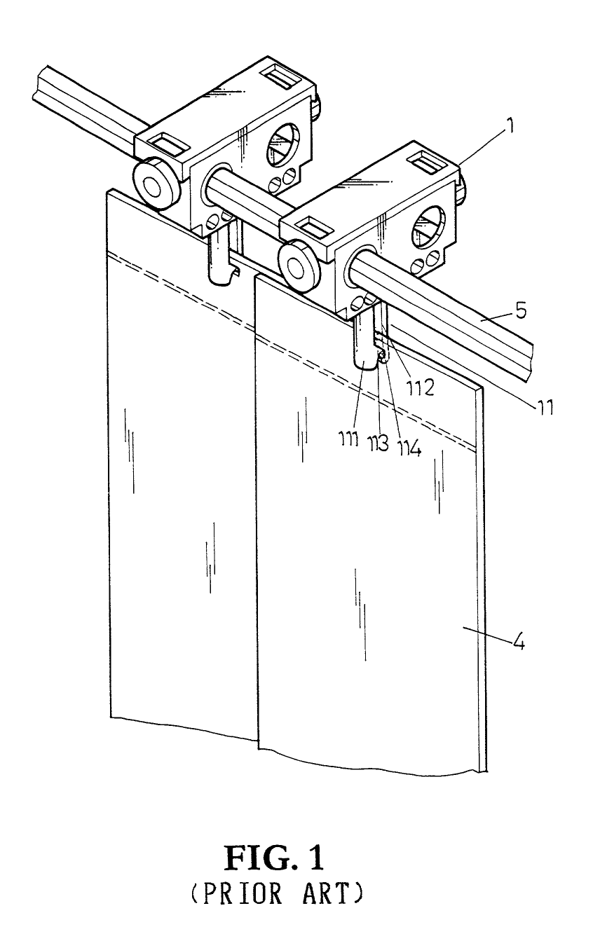

FIG. 2 is a perspective view of a portion of another conventional window covering assembly.

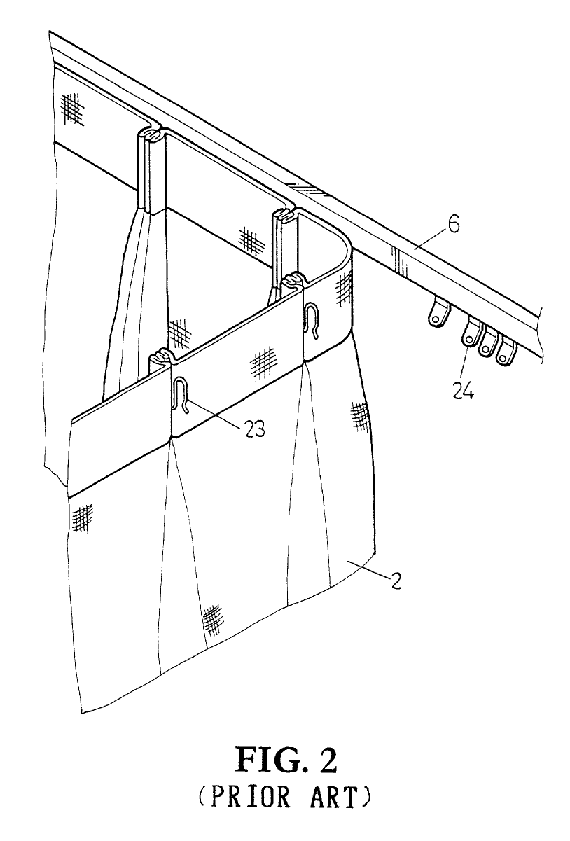

FIG. 3 is a perspective view of a slide having a connecting member in accordance with the present invention.

FIG. 4 is a perspective view of a portion of a window covering assembly using the slide having the connecting member in accordance with the present invention.

FIG. 5 is a perspective view of a portion of another window covering assembly using the slide having the connecting member in accordance with the present invention.

FIG. 6 is a perspective view similar to FIG. 5, wherein the curtain of the window covering assembly is in a folded state.

### DETAILED DESCRIPTION OF THE PREFERRED EMBODIMENT

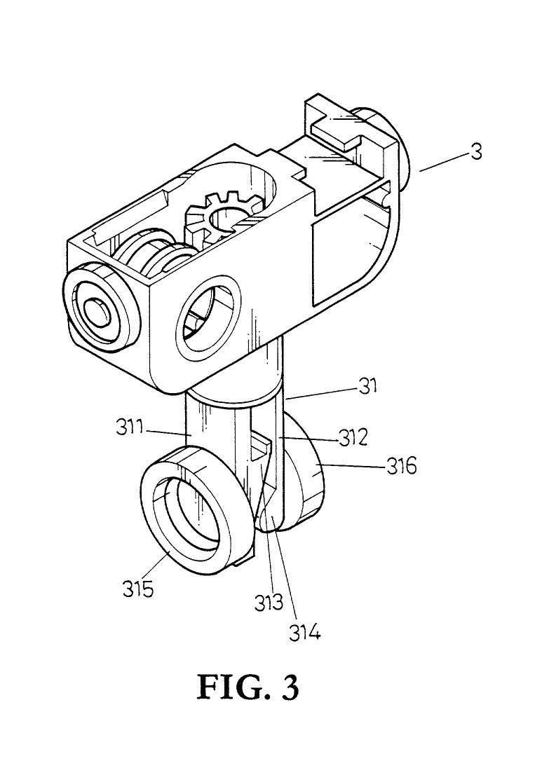

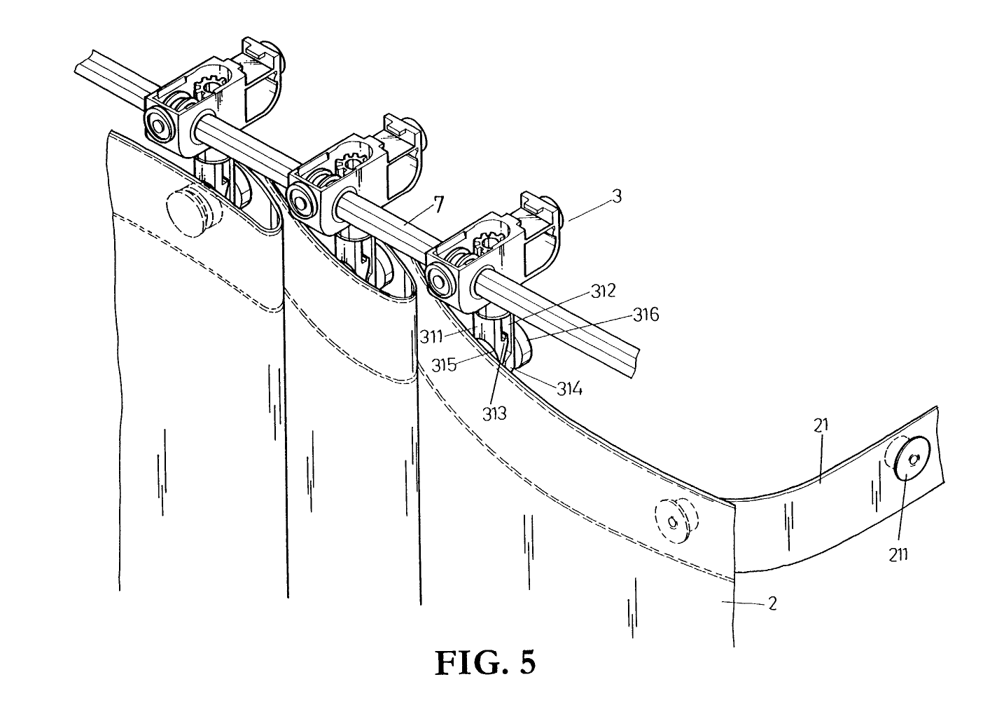

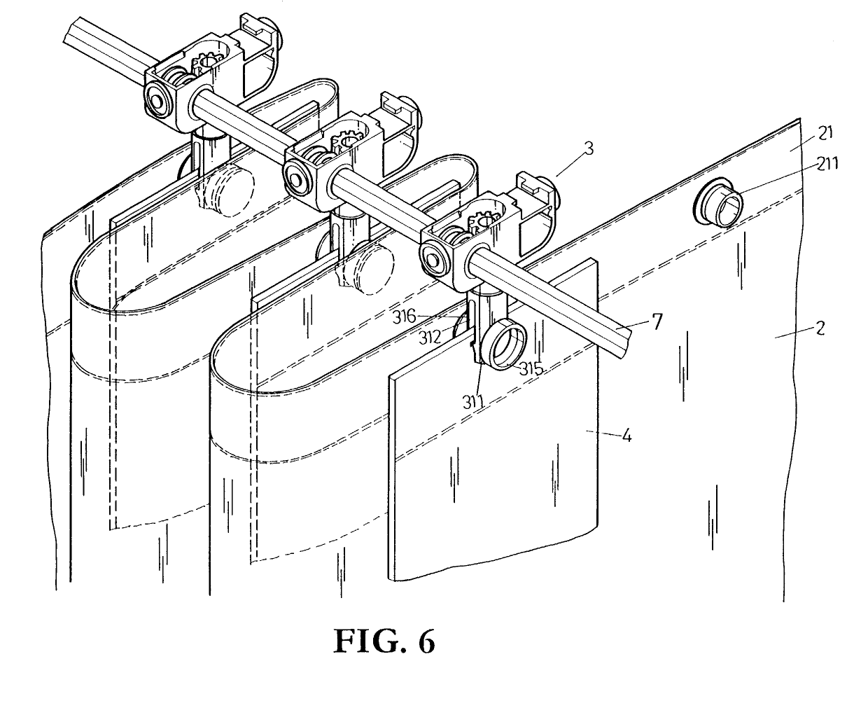

Referring to FIGS. 3 through 6, a slide 3 for a window covering assembly in accordance with the present invention generally comprises a connecting member 31 attached thereto to move therewith. An angular position of the connecting member 31 can be adjusted according to need. A lower portion of the connecting member 31 is branched into two clamping elements 311 and 312 each having a hook 313, 314 on an inner face thereof for engaging with a slat 4 made of plastic material. Each clamping element 311, 312 further comprises an engaging member 315, 316.

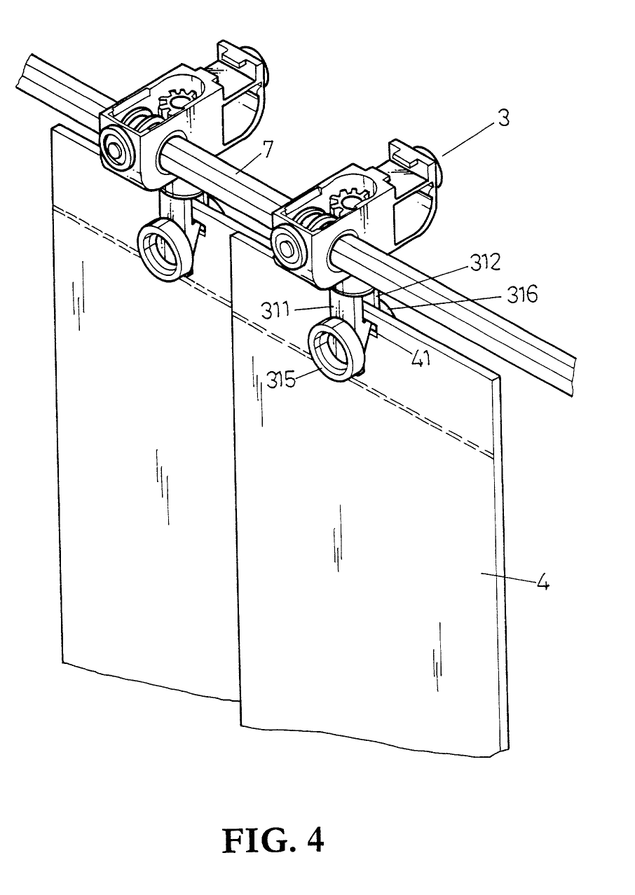

FIG. 4 illustrates a window covering assembly having plural slides 3 slidably mounted to a rod 7, and plural slats 4 are engaged with the connecting members 31 to move therewith. Each slat 4 has a slot 41 for engaging with the hooks 313 and 314 of the clamping elements 311 and 312. The slats 4 can be adjusted in angular positions thereof to change the incident angle of light.

When it is desired to replace the slats 4 with a drape, lace, casement, print, or curtain 2, the slats 4 can be removed from the connecting members 311 and 312, and the curtain 2 is then attached to the connecting members 311 and 312. The curtain 2 has plural spaced engaging members 211 provided to an upper edge 21 thereof. The engaging members 211 are releasably engaged with the engaging members 315 and 316 of the clamping members 311 and 312. Preferably, each of the engaging members 315 and 316 is a male engaging member or a female engaging member. The curtain 2 can be manipulated to adjust the quantity of the incident light beams and to provide a romantic atmosphere.

According to the above description, it is appreciated that the connecting members 31 in accordance with the present invention allows rapid, convenient interchange of the window coverings.

Although the invention has been explained in relation to its preferred embodiment, it is to be understood that many other possible modifications and variations can be made without departing from the scope of the invention as hereinafter claimed.

What is claimed is:

1. A connecting member of a slide of a window covering assembly, the connecting member comprising:
a lower end branching into two clamping elements each having a hook on an inner face thereof for releasably engaging with a first type of window coverings, each said clamping element further comprising an engaging member for releasably engaging with a second type of window coverings.

2. The connecting member of a slide of a window covering assembly as claimed in claim 1, wherein each said engaging member is one of a male engaging member and a female engaging member.
